(19) United States
(12) Patent Application Publication
(10) Pub. No.: US 2023/0161937 A1
(43) Pub. Date: May 25, 2023

(54) MASK LAYOUT DESIGN METHOD, MASK AND INTEGRATED CIRCUIT MANUFACTURING METHODS, MASKS AND INTEGRATED CIRCUITS

(71) Applicant: Samsung Electronics Co., Ltd., Suwon-si (KR)

(72) Inventors: Somin Cheon, Hwaseong-si (KR); Joonsung Kim, Hwaseong-si (KR); Jaewan Song, Hwaseong-si (KR); Seunghune Yang, Seoul (KR); Sooyong Lee, Yongin-si (KR)

(21) Appl. No.: 17/951,580

(22) Filed: Sep. 23, 2022

(30) Foreign Application Priority Data
Nov. 23, 2021 (KR) 10-2021-0162790

(51) Int. Cl. G06F 30/3323; G03F 7/20

(52) U.S. Cl. CPC G06F 30/3323; G03F 7/70433; G03F 7/705; G06F 2119/18

(57) ABSTRACT

A mask layout design method capable of quickly and effectively designing a crack-resistant mask layout in a full-chip scale, a mask manufacturing method including the mask layout design method, and a mask layout are provided. The mask layout design method includes designing a full-chip layout with respect to a mask; extracting a representative pattern from the full-chip layout; detecting a stress weak point in the representative pattern; verifying the stress weak point by forming a pattern on a wafer; and changing a design rule with respect to the full-chip layout.

### CROSS-REFERENCE TO RELATED APPLICATION

This application is based on and claims priority under 35 U.S.C. § 119 to Korean Patent Application No. 10-2021-0162790, filed on Nov. 23, 2021, in the Korean Intellectual Property Office, the disclosure of which is incorporated by reference herein in its entirety.

### BACKGROUND

The inventive concept relates to a mask and integrated circuit manufacturing methods, and more particularly, to a mask layout design method, a mask manufacturing method to manufacture photolithographic masks including the designed mask layout (which may include the mask layout design method, an integrated circuit manufacturing method to manufacture integrated circuits using one or more of such masks, and resulting masks and integrated circuits manufactured with such methods).

In a semiconductor process, a photolithography process using a mask may be performed to form a pattern in a layer formed on a semiconductor substrate such as a wafer. A mask may be simply viewed as a pattern transfer body in which a pattern shape of an opaque material of the mask is transferred to a base material, such as a layer formed on the semiconductor substrate or the semiconductor substrate itself. In a mask manufacturing process, a firstly required circuit is designed, a layout with respect to the circuit is designed, and then mask design data (e.g., mask tape-out (MTO) design data) after performing optical proximity correction (OPC). Thereafter, mask data preparation (MDP) is performed based on the MTO design data, a front end of line (FEOL) such as an exposure process and a back end of line (BEOL) such as a defect inspection are performed, and thus the mask may be manufactured. The mask then may be used in a photolithographic process to manufacture integrated circuits (e.g., formed as a semiconductor chip) in a semiconductor manufacturing process.

### SUMMARY

The inventive concept provides a mask layout design method capable of quickly and effectively designing a crack-resistant mask layout on a full-chip scale, a mask manufacturing method including the mask layout design method, a mask, an integrated circuit manufacturing method using the mask and an integrated circuit.

In addition, the problems to be solved by the technical spirit of the inventive concept are not limited to the problems mentioned above, and other problems may be clearly understood by those skilled in the art from the following description.

According to an aspect of the inventive concept, there is provided manufacturing method including designing a full-chip layout; extracting a representative pattern from the full-chip layout; detecting a stress weak point in the representative pattern; verifying the detected stress weak point including forming a pattern on a wafer; changing a design rule with respect to the full-chip layout to obtain a modified full-chip layout; and forming at least one of a mask and an integrated circuit based on analysis of the modified full-chip layout.

According to another aspect of the inventive concept, there is provided a manufacturing method including designing a first layout; extracting a representative pattern from the first layout through a unique pattern extraction method; detecting a stress weak point based on a stress simulation using a finite element method (FEM) with respect to the representative pattern; verifying the detected stress weak point including forming a pattern on a wafer; changing a design rule with respect to the first layout by using a shape optimization method; designing a second layout according to the changed design rule; and forming at least one of a mask and a semiconductor chip in response to analysis of the second layout, wherein the first layout and the second layout are layouts with respect to a full-chip.

According to another aspect of the inventive concept, there is provided a manufacturing method including performing a mask layout design method; performing optical proximity correction (OPC) on a final full-chip layout obtained through the mask layout design method; transferring data of the optical proximity corrected full-chip layout data as mask tape-out (MTO) design data; preparing mask data based on the MTO design data; and exposing a mask blank based on the mask data, wherein the performing of the mask layout design method includes: designing a full-chip layout ; extracting a representative pattern from the full-chip layout; detecting a stress weak point in the representative pattern via simulation; verifying the detected stress weak point including forming a pattern on a wafer; and changing a design rule with respect to the full-chip layout.

According to another aspect of the inventive concept, there is provided a mask including a first pattern area extending in a first direction and including first line patterns spaced apart from each other in a second direction perpendicular to the first direction; and a second pattern area disposed adjacent to the first pattern area and including second line patterns or contact patterns, wherein patterns of the second pattern area are arranged to minimize cracks with respect to the first line patterns of the first pattern area.

### BRIEF DESCRIPTION OF THE DRAWINGS

Embodiments of the inventive concept will be more clearly understood from the following detailed description taken in conjunction with the accompanying drawings in which:

FIG. 1 is a flowchart schematically illustrating a process of a mask layout design method according to an embodiment of the inventive concept;

FIG. 2 is a conceptual diagram illustrating an operation of extracting a representative pattern in the mask layout design method of FIG. 1;

FIGS. 3A and 3B are respectively a flowchart illustrating an operation of extracting a representative pattern in the mask layout design method of FIG. 1 in more subdivided operations, and an image corresponding to the subdivided operations;

FIGS. 4A to 4D are respectively a flowchart illustrating an operation of detecting a stress weak point in the mask layout design method of FIG. 1 in more subdivided operations, a perspective view and a plan view illustrating stress with respect to a wafer including a coating layer on a substrate, and a conceptual diagram illustrating a principle of a finite element method (FEM);

FIG. 5 is a graph illustrating a stress weak point detection speed of the mask layout design method of FIG. 1 and stress weak point detection speeds of comparative examples in a full-chip scale;

FIG. 6 is a flowchart illustrating a verifying operation by forming a pattern on a wafer in the mask layout design method of FIG. 1 in more subdivided operations;

FIGS. 7A to 7C are scanning electron microscope (SEM) images illustrating parts where cracks occur in semiconductor devices on a wafer;

FIGS. 8A to 8D illustrate images of a mask layout corresponding to a verifying operation by forming a pattern on a wafer in an operation of extracting a representative pattern included in the mask layout design method of FIG. 1;

FIG. 9 is a graph illustrating an operation of changing a design rule with respect to a mask layout, in the mask layout design method of FIG. 1;

FIGS. 10A and 10B are conceptual views illustrating a shape optimization method applied to an operation of changing a design rule with respect to a mask layout, in the mask layout design method of FIG. 1;

FIGS. 11A and 11B are images illustrating stress simulation results according to a shape optimization method;

FIGS. 12A to 12D illustrate images of mask layouts obtained by applying the mask layout design method of FIG. 1 to an actual semiconductor device;

FIGS. 13A to 13D illustrate images of mask layouts obtained by applying the mask layout design method of FIG. 1 to an actual semiconductor device;

FIGS. 14A and 14B are plan views of semiconductor devices corresponding to the mask layouts of FIGS. 13A and 13D; and

FIG. 15 is a flowchart schematically illustrating a manufacturing method including a mask layout design method according to an embodiment of the inventive concept.

### DETAILED DESCRIPTION OF THE EMBODIMENTS

Hereinafter, embodiments of the inventive concept will be described in detail with reference to the accompanying drawings. The same reference numerals are used for the same components in the drawings, and redundant descriptions thereof may be omitted.

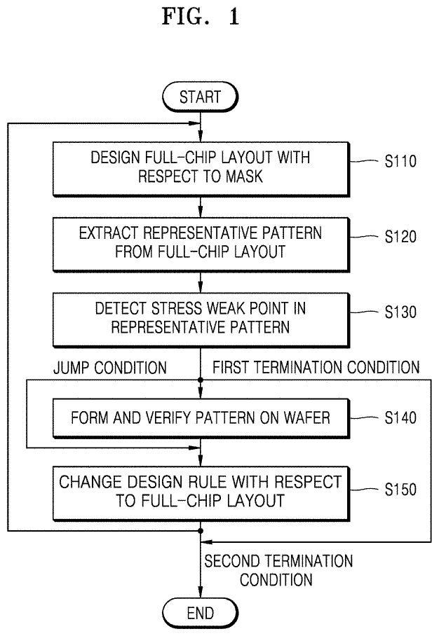

FIG. 1 is a flowchart schematically illustrating a process of a mask layout design method according to an embodiment of the inventive concept.

Referring to FIG. 1, in the mask layout design method of the present embodiment, a full-chip layout with respect to a mask is first designed (S110). In order to manufacture a semiconductor device, circuit patterns constituting the semiconductor device need to be formed. In addition, the circuit patterns of the semiconductor device may be formed through a process of transferring a pattern on a mask to a layer of a substrate such as a wafer through an exposure process. Accordingly, a layout of the patterns of a mask corresponding to circuit patterns of the semiconductor device to be manufactured needs to be designed. A full-chip layout of the semiconductor device refers to a layout of an entire single chip (e.g., a patterned layer of a chip, between the boundaries of the chip (such as edges of the chip after being cut from a wafer)). For reference, a full-shot layout has a concept similar to a full-chip and refers to a layout corresponding to an entire mask that is transferred to a wafer at one time during a single exposure (i.e., the layout transferred by a single exposure shot).

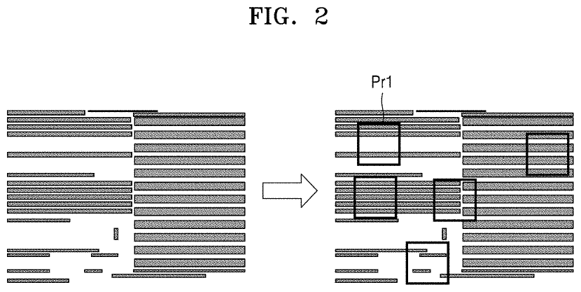

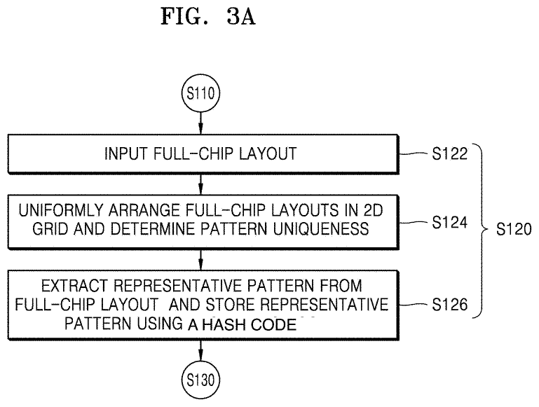

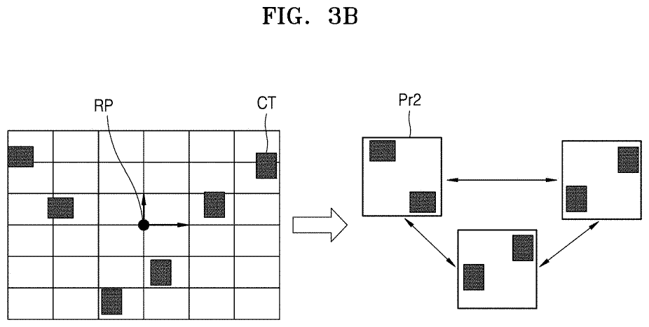

Next, a representative pattern is extracted from the full-chip layout (S120). The representative pattern may be identified as a unique pattern that represents each of several repeated patterns among a plurality of patterns included in the full-chip layout and may be distinguished from other patterns of the plurality of patterns. In the mask layout design method of the present embodiment, the representative pattern may be extracted through a unique pattern extraction method. The unique pattern extraction method will be described in more detail with reference to FIGS. 2 to 3B.

The representative pattern also may be extracted through a pattern matching method. The pattern matching method may comprise extracting a corresponding pattern in the full-chip layout as the representative pattern by comparing a previously identified preset pattern (e.g., stored in a database as part of a pattern library) to the full-chip layout. The pattern matching method may be used in place of, or in conjunction with, the unique pattern extraction method. It will be appreciated that several different representative patterns may exist in the full-chip layout, and the method described herein may be applied with respect to each of such representative patterns. In addition, the pattern matching method may first be applied to the full-chip layout to identify previously identified preset patterns (e.g., those stored in the database) as representative patterns, and then the unique pattern extraction method may be applied to the remaining portions of the full-chip layout to identify unique patterns therein (e.g., unique patterns that have not been previously identified and stored in the database). In some examples, the identified unique patterns may be stored in the database as part of the pattern library and thus be treated as preset patterns during a later implementation of this method. It should be appreciated that the previously identified preset patterns (e.g., stored in a database as part of a pattern library) may have been obtained from unique patterns in the design of other semiconductor devices.

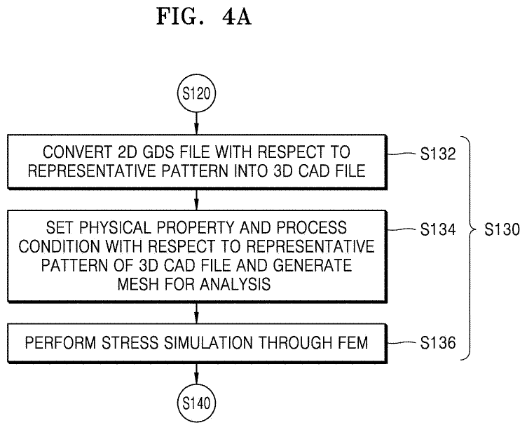

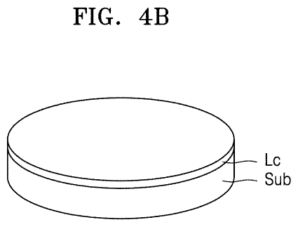

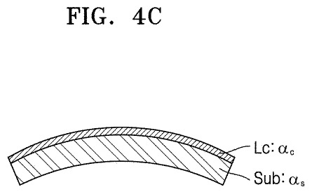

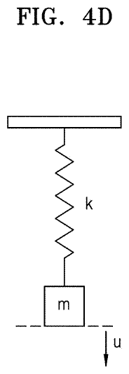

Thereafter, a stress weak point is detected from analysis of the representative pattern (S130) (e.g., through a simulation that applies stress to the representative pattern). The stress weak point may be a point in the representative pattern where high stress is applied. In addition, because cracks or warpage usually occur at a point where stress is high, the stress weak point may be a point where damage, such as cracks or warpage, is likely to occur. In the mask layout design method of the present embodiment, the stress weak point may be detected through stress simulation using a finite element method (FEM). In addition, a point where stress greater than or equal to a set threshold stress is applied may be detected as the stress weak point. It will be appreciated that several such stress weak points may be identified in a representative pattern and the method described herein may be applicable to each identified stress weak points. The FEM will be described in more detail with reference to FIGS. 4A to 4C.

After performing the stress weak point detection (S130), the following two determination processes may be performed. The first determination process is whether a first termination condition is satisfied. For example, the first termination condition is that there is no detected stress weak point. When this first termination condition is satisfied, the mask layout design method is terminated. The case where there is no stress weak point detected in operation S130 may be interpreted in two ways. The first way may be attributed to an error in a stress simulation. The second way is that the full-chip layout may not actually have a stress weak point.

The second determination process is whether a jump condition is satisfied. For example, the jump condition may be satisfied when a first number of repetitions set with respect operation S130 of detecting the stress weak point has been reached. When the set first number of repetitions is two, after the second operation S130 of detecting the a stress weak point, operation S150 of changing the design rule may be performed by jumping verifying operation S140. Verifying operation S140, which takes a long time, may therefore be omitted, thereby greatly reducing the total time of the mask layout design method.

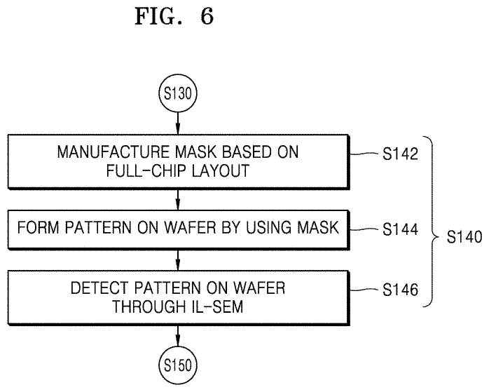

After detecting the stress weak point, when the two determination processes are not satisfied, verification is performed by forming a pattern on the wafer (S140). The pattern on the wafer correspond to a pattern of a semiconductor device to be manufactured (e.g., forming a pattern on a layer of the wafer that comprises a several identical semiconductor devices, each semiconductor device would thus have a the identical full-chip layout (patterned layer) formed). Verifying operation S140 by forming the pattern on the wafer may correspond to a process of verifying whether points detected through operation S120 of extracting the representative pattern(s) and operation S130 of detecting the stress weak point(s) are stress weak points where cracks or warpage actually occur. Verifying operation S140 by forming the pattern on the wafer will be described in more detail with reference to FIG. 6.

In addition, although not shown in the flowchart of FIG. 1, when a first point (e.g., a theoretical stress weak point determined from a simulation analysis) detected as the stress weak point in operation S130 of detecting the stress weak point is different from a second point (e.g., a stress weak point detected in a physical pattern) detected as the stress weak point in verifying operation S140 by forming a pattern on a wafer, detailed conditions in operation S120 of analyzing the cause and extracting the representative pattern and/or operation S130 of detecting the stress weak point may be changed. Thereafter, operation S120 of analyzing the cause and extracting the representative pattern to verifying operation S140 by forming the pattern on the wafer may be repeated again. Meanwhile, when the first point detected as the stress weak point (e.g., a theoretical stress weak point determined from a simulation analysis) in operation S130 of detecting the stress weak point is the same as the second point detected as the stress weak point (e.g., a stress weak point detected in a physical pattern) in verifying operation S140 by forming the pattern on the wafer, the stress simulation of operation S130 of detecting the stress weak point may be seen as effective in detecting the stress weak point. Therefore, with respect to a subsequent analysis of the full-chip layout, verifying operation S140 may be unnecessary and may be omitted by the jump condition as noted above.

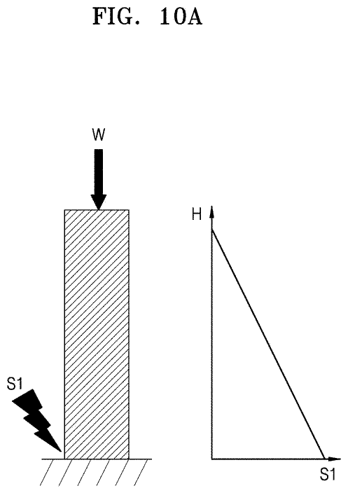

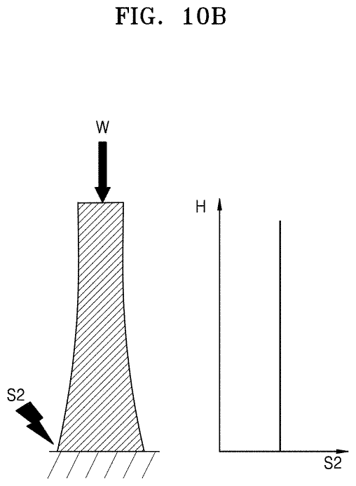

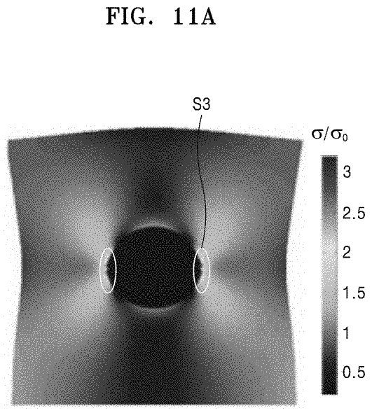

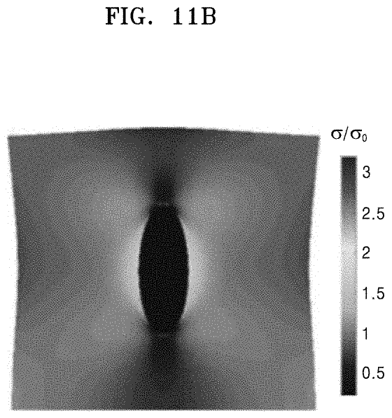

After verification, the design rule with respect to the full-chip layout may be changed (S150). The design rule for the full-chip layout may be changed so that the previously detected stress weak point (S130 and possibly verified in S140) is removed or mitigated in the representative pattern (as reconfigured based on the modified design rule). It will be appreciated that more than one design rule may be changed in S150 to remove a detected stress weak point. In the mask layout design method of the present embodiment, the design rule may be changed through a shape optimization method. The shape optimization method will be described in more detail with reference to FIGS. 10A to 11B.

Meanwhile, when the stress weak point is not detected in operation S130 of detecting the stress weak point, that is, when the first termination condition is satisfied, operation S150 of changing the design rule may be omitted. For example, when the stress simulation fails to detect a stress weak point due to an error, criteria for changing the design rule may be ambiguous. In addition, when a stress weak point is not detected because the full-chip layout is optimally designed, there is no need to change the design rule with respect to the full-chip layout.

The change in the design rule for the full-chip layout in S150 may result in modification of the full-chip layout. Thus, after the design rule is changed, and when the second termination condition is not satisfied, the process may proceed to operation S110 of designing the full-chip layout to incorporate the changed design rule (e.g., to obtain a modified full-chip layout). Here, the second termination condition is a second number of repetitions set with respect to operation S150 of changing the design rule. For example, when the set second number of repetitions is 10, after a tenth operation S150 of changing the design rule, the mask layout design method is terminated. As described above, the number of cycles in the mask layout design method may be limited through the second termination condition, thereby preventing an infinite loop that may be caused by an unknown error. Determination of whether the second determination is satisfied may occur earlier in the mask layout design method, such as immediately after detecting a stress weak point in S130.

After S150, when the process proceeds to operation S110 of designing the full-chip layout, operation S110 of designing the full-chip layout may include designing the full-chip layout again according to the changed design rule. Thereafter, processes after operation S110 of designing the full-chip layout may be repeated until the first termination condition or the second termination condition is satisfied.

The mask layout design method of the present embodiment may accurately and quickly detect the stress weak point in the full-chip layout, by using the unique pattern extraction method and the FEM. In addition, the design rule with respect to the full-chip layout may be changed through the shape optimization method, thereby designing the optimal layout with respect to the full-chip. As a result, the mask layout design method of the present embodiment makes it possible to quickly and effectively design the full-chip layout that minimizes stress and is resistant to cracks.

FIG. 2 is a conceptual diagram illustrating an operation of extracting a representative pattern Pr1 in the mask layout design method of FIG. 1 (e.g., in accordance with S120). The description given with reference to FIG. 1 will be briefly explained or omitted.

Referring to FIG. 2, the left image shows a part of a full-chip layout. The right image shows several patterns identified as corresponding unique patterns in in square boxes. As described above, the representative pattern Pr1 may be a unique pattern that represents a pattern that is repeated in the full-chip layout and is distinguishable from other patterns. For example, in FIG. 2, the representative patterns of the square boxes are different from each other. Also, FIG. 2 illustrates that the pattern in the upper right square box represents identical patterns in different positions in FIG. 2. The other representative patterns may represent identical patterns at different locations in the full-chip layout at other portions of the full-chip layout that are not shown in FIG. 2.

FIGS. 3A and 3B are respectively a flowchart illustrating an operation (e.g., S120) of extracting a representative pattern in the mask layout design method of FIG. 1 in more subdivided operations, and an image corresponding to the subdivided operations.

Referring to FIGS. 3A and 3B, in the mask layout design method of the present embodiment, operation S120 of extracting the representative pattern may include first receiving a full-chip layouts (S122). In other words, data with respect to the full-chip layout is input. The data with respect to the full-chip layout may have, for example, a two-dimensional (2D) graphic design system (GDS) file format. However, the data with respect to the full-chip layout is not limited to the file format described above.

Next, the full-chip layout is uniformly arranged in a 2D grid, and a pattern uniqueness is determined (S124). The left image of FIG. 3B shows the arrangement of contacts CT, which are part of a full-chip layout, in a grid. A central point, which is a reference point, may be a criterion for determining the pattern uniqueness together with grids

Thereafter, a unique pattern is extracted as a representative pattern and stored using a hash code (S126). As shown in FIG. 3B, a unique pattern Pr2 is extracted as a representative pattern, corresponding to three portions of the pattern of the full-chip layout shown on the left side of FIG. 3B. Here, the hash code means a bit string, which is an output of a hash function. The hash function is a function that maps data of an arbitrary length to data of a fixed length, and a value obtained by the hash function is called the hash code, or simply a hash. The hash function may be used in a data structure called a hash table, and may be widely used in computer software for a very fast data retrieval. For example, on the right side of FIG. 3B, contact patterns in three square boxes may all have the same hash code and be recognized as the same pattern. Accordingly, one of the three square boxes may be extracted and stored as a representative pattern Pr2.

FIGS. 4A to 4D are respectively a flowchart illustrating an operation of detecting a stress weak point in the mask layout design method of FIG. 1 in more subdivided operations, a perspective view and a plan view illustrating stress with respect to a wafer including a coating layer Lc on a substrate Sub, and a conceptual diagram illustrating a principle of an FEM. The description given with reference to FIG. 1 will be briefly explained or omitted.

Referring to FIGS. 4A to 4D, in the mask layout design method of the present embodiment, operation S130 of extracting the stress weak point includes first converting a 2D GDS file with respect to a representative pattern into a three-dimensional (3D) computer aided design (CAD) file (S132). In general, stress is a function of a 3D shape. Therefore, a process of converting the 2D GDS file with respect to the representative pattern into the 3D CAD file may be necessary.

Next, a physical property and a process condition with respect to the representative pattern of the 3D CAD file are set, and a mesh for analysis is generated (S134). Here, the physical property means a characteristic of a material constituting the representative pattern, and may include, for example, the Young's Modulus and a coefficient of thermal expansion used in stress calculation equations of FIGS. 4B and 4C. In addition, the mesh may mean a mesh obtained by finely decomposing the representative pattern in order to apply the FEM to the representative pattern. The mesh may divide the 3D representation of the representative pattern (as provided in the 3D CAD file) into a 3D distribution of cells, with each cell identifying a 3D portion of the 3D representative pattern.

Thereafter, a stress simulation through the FEM is performed on the representative pattern (S136). The FEM, which is a numerical analysis method in structural analysis, fluid analysis, thermal analysis, and magnetic field analysis, is a method of dividing an analysis target into a finite number of regions (or elements, here the cells of the representative pattern described above), determining a junction representing the regions, and then approximating a governing equation of the junction to a system of linear equations to solve the analysis target. For reference, a module that automatically performs element segmentation, that is, mesh generation, is called a preprocessor, a module that solves the system of linear equation is called a solver, and a module that displays analysis results in graphics is called a postprocessor. These modules may correspond to software modules that configure processor(s) (e.g., one or more CPUs (central processing units), GPUs (graphical processing units) or other computer processors of a computer), or may correspond to dedicated hardware (e.g., an FPGA (field programmable gate array, DSP (digital signal processor), etc.)). The stress simulation performed on the representative pattern may provide the detected stress weak points for all of the patterns corresponding to the representative pattern in the full-chip layout, and thus, separate stress simulations for each of the representative patterns may be avoided.

FIG. 4B is a perspective view of a wafer including the coating layer Lc on the substrate Sub. FIG. 4C is a cross-sectional view of the wafer. As thermal expansion rates of the substrate Sub and the coating layer Lc are different from each other, thermal stress of the wafer due to a change in the temperature may be generated. For example, the thermal stress of the wafer may be expressed by the following Equation (1).

σ_{c}=σₛ=(EcEs(α_{c}−αₛ)ΔT)/(Ex+Ex) Equation (1)

In Equation (1), σ_{c} and σₛ denote pieces of stress applied to the coating layer Lc and the substrate Sub, respectively, Ec and Es denote the Young's modulus of the coating layer Lc and the substrate Sub, respectively, α_{c} and αₛ denote thermal expansion coefficients of the coating layer Lc and the substrate Sub, respectively, and ΔT denotes the change in the temperature.

As described above, it is not easy to solve the stress of the entire representative pattern by using a single equation. Accordingly, in the mask layout design method of the present embodiment, the stress on the entire representative pattern may be solved by using the FEM. For example, the stress may be solved by approximating a tensor equation to an equation of Hooke's law by using the FEM, as shown in FIG. 4D.

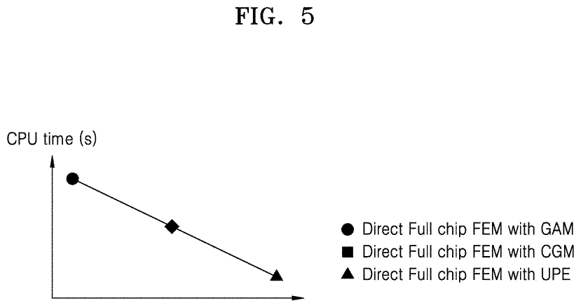

FIG. 5 is a graph illustrating a stress weak point detection speed of the mask layout design method of FIG. 1 and stress weak point detection speeds of comparative examples in a full-chip scale.

Referring to FIG. 5, from the upper left to the lower right, in the case of a first comparative example (●) in which a direct full-chip FEM is applied by using a Gauss Seidel method (GSM), the stress weak point detection speed is about 6.1*10²⁵s, and in the case of a second comparative example (▪) in which the direct full-chip FEM is applied by using a conjugate gradient method (CGM), the stress weak point detection speed is about 9.0*10¹¹s. Meanwhile, in the case of a hybrid method (▴) of applying an FEM covering a full-chip by using unique pattern extraction (UPE) in the mask layout design method of the present embodiment, the stress weak point detection speed is about 1.0*10⁻³s. Accordingly, it may be seen that the stress weak point detection speed in the mask layout design method of the present embodiment is at least 10¹⁴ times faster than the stress weak point detection speeds of the comparative examples. However, in the mask layout design method of the present embodiment, it is a result of extracting 100 representative patterns. Accordingly, as the number of representative patterns increases, the speed of detecting the stress weak point may also increase.

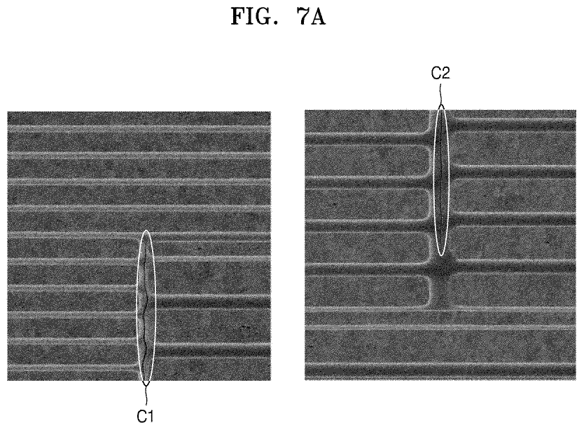

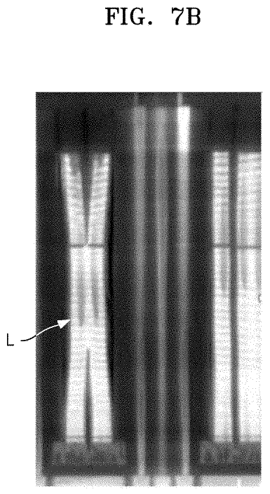

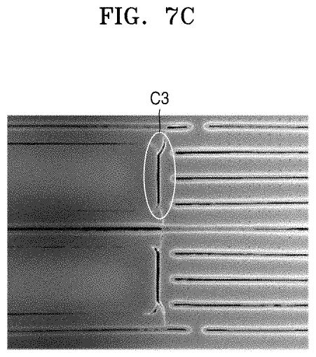

FIG. 6 is a flowchart illustrating an example of the verifying operation S140 by forming a pattern on a wafer in the mask layout design method of FIG. 1 in more subdivided operations. FIGS. 7A to 7C are scanning electron microscope (SEM) images illustrating parts where cracks occur in semiconductor devices on a wafer. The description given with reference to FIG. 1 will be briefly explained or omitted.

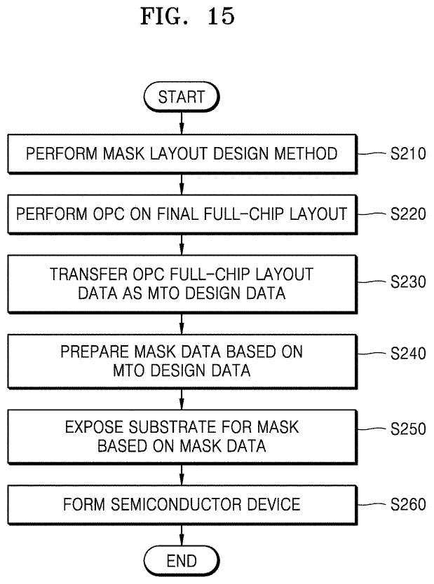

Referring to FIG. 6, in the mask layout design method according to the present embodiment, verifying operation S140 by forming the pattern on the wafer includes first manufacturing a mask based on a full-chip layout (S142). The mask may be manufactured by performing optical proximity correction (OPC) with respect to the full-chip layout, transferring mask tape-out (MTO) design data, preparing mask data, patterning a mask blank, etc. A process of manufacturing the mask will be described in more detail in a method of manufacturing with reference to FIG. 15.

Thereafter, a pattern is formed on the wafer using the mask (S144). Specifically, a photoresist (PR) is applied on the wafer, an exposure process is performed using the mask, and a development process is performed on the exposed PR to form a PR pattern. Subsequently, the pattern may be formed on the wafer, by etching the substrate of the wafer or a material film on the substrate using the PR pattern. Thus, the pattern of the mask may be represented in a pattern of the material film or substrate of the wafer.

Next, the pattern on the wafer is detected by imaging, such as using an in-line (IL) SEM. Here, IL may mean performing a process in real time. Here, the detection may mean a process of detecting a stress weak point, for example, cracks or warpage through the SEM image. Sensing techniques other than (or in addition to) imaging may be used to detect stress weak points.

Referring to FIGS. 7A to 7C, FIGS. 7A and 7C illustrate cracks C1, C2, and C3 generated in the semiconductor devices on the wafer. As may be seen from FIGS. 7A and 7C, in the semiconductor devices, the cracks C1, C2, and C3 may mainly occur at boundaries between different patterns. FIG. 7B illustrates warpage or inclination L occurring in the semiconductor device on the wafer. For example, FIG. 7B may illustrate a structure in which a mold is warped during a process of manufacturing a vertical nonvolatile memory device.

As described above, based on the full-chip layout, the pattern may be formed on the wafer and stress weak points may be actually detected. In addition, the accuracy of operation S130 of detecting the stress weak point may be verified, by comparing positions of the actually detected stress weak points with those of stress weak points previously detected in operation S130 of detecting the stress weak point. Therefore, the accuracy of detection of the stress weak point in a stress simulation using an FEM may be verified.

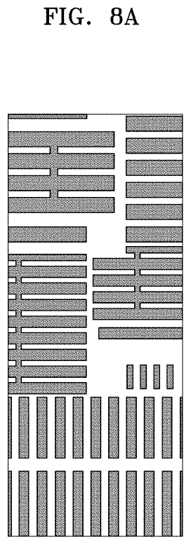

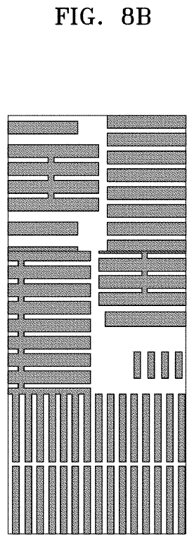

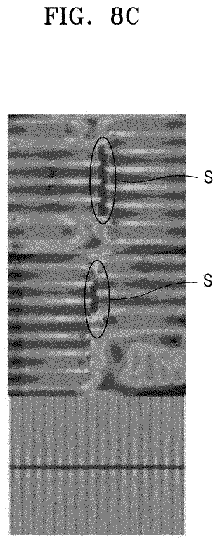

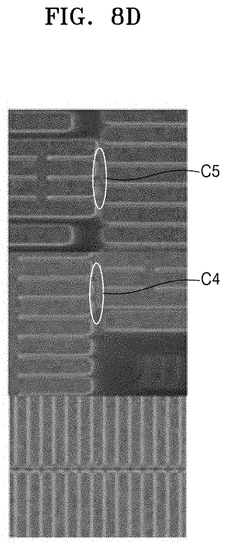

FIGS. 8A to 8D illustrate images of a mask layout corresponding to the verifying operation S140 by forming a pattern on a wafer from operation S120 of extracting a representative pattern included in the mask layout design method of FIG. 1. The descriptions given with reference to FIGS. 1 to 7B will be briefly explained or omitted.

Referring to FIG. 8A, in the mask layout design method of the present embodiment, a layout image of the representative pattern extracted from a full-chip layout is illustrated in connection with operation S120 of extracting the representative pattern. For example, the representative pattern may include a line end (LE) and an LE space. The LE may mean an end of a line pattern in a line and space pattern, and the LE space may mean a space between patterns having different LEs, in particular, between different LEs. As described above, the full-chip layout may be represented by a 2D GDS file format, and accordingly, the layout of the extracted representative pattern may also have the 2D GDS file format. However, file formats of the full-chip layout and the layout of the representative pattern are not limited to the 2D GDS file format.

Referring to FIG. 8B, in the mask layout design method of the present embodiment, in connection with operation S130 of detecting the stress weak point, an image obtained by converting a 2D GDS file with respect to the layout of the representative pattern into a 3D CAD file is illustrated. As may be seen from FIGS. 8A and 8B, the layout of the representative pattern may not significantly differ in view of a 2D image. Meanwhile, conversion of the 2D GDS file into the 3D CAD file of FIG. 8B may correspond to operation S132 of converting the 2D GDS file into the 3D CAD file in FIG. 4A.

Meanwhile, although the corresponding image is not shown, after operation S132 of converting the 2D GDS file into the 3D CAD file, a process of setting a physical property and a process condition with respect to the representative pattern, and generating a mesh for analysis may be performed. That is, operation S134 of generating the mesh in FIG. 4A may be performed.

Referring to FIG. 8C, in the mask layout design method of the present embodiment, in connection with operation S130 of detecting the stress weak point, a black and white stress image is shown with respect to the representative pattern obtained in the stress simulation using the FEM. The process of obtaining the stress image of FIG. 8C may correspond to operation S136 of performing the stress simulation through the FEM in FIG. 4A. In the black and white stress image of FIG. 8C, a dark black part indicated by a black oval may correspond to stress weak points S of high stress. It may be seen that these stress weak points S correspond to the LE space, in particular, a space in which LEs are adjacent to each other.

Referring to FIG. 8D, in the mask layout design method of the present embodiment, in connection with verifying operation S140, a black and white SEM image is shown with respect to the pattern on the wafer. A process of obtaining the SEM image in FIG. 8D may correspond to operation S146 of detecting a pattern using an IL-SEM in FIG. 6. Before operation S146 of detecting the pattern using the IL-SEM, operation S142 of generating a mask and operation S144 of forming the pattern on the wafer may be performed. In the black and white image of FIG. 8D, it may be confirmed that cracks C4 and C5 actually occur in a part indicated by a white oval. In addition, it may be seen that positions of the cracks C4 and C5 exactly match the stress weak points S of the black and white image of FIG. 8C. Accordingly, the accuracy of operation S130 of detecting the stress weak point or the accuracy of the stress simulation using the FEM may be verified.

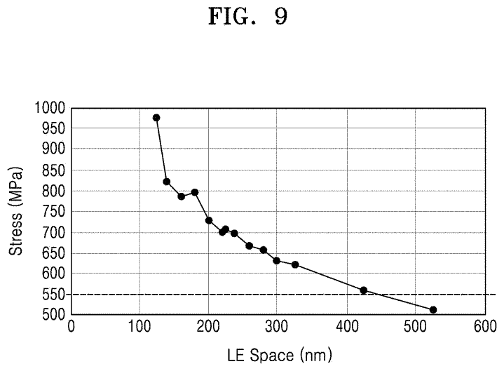

FIG. 9 is a graph illustrating an operation of changing a design rule with respect to a mask layout, in the mask layout design method of FIG. 1, wherein the x-axis represents an LE space in unit of nm, and the y-axis represents stress in units of MPa.

Referring to FIG. 9, in the mask layout design method of the present embodiment, operation S130 of detecting a stress weak point may include calculating stress with respect to a representative pattern through a stress simulation using an FEM. Also, as shown in FIG. 9, a relationship between the LE space and the stress may be indicated in the graph. In the graph, a dashed line may correspond to threshold stress at which damage, such as cracks or warpage, does not occur. In other words, a part exceeding the threshold stress may correspond to a part of the stress weak point, and a part equal to or less than the threshold stress may correspond to a normal part in which stress is not high. Here, the threshold stress may be, for example, statistically determined considering a relationship between a part in which cracks or warpage, etc. occur in the pattern in verifying operation S140 and the stress obtained through the stress simulation.

Meanwhile, it may be seen from the graph of FIG. 9 that the stress weak point does not occur when the LE space is maintained to be equal to or more than 420 nm. As described above, based on the stress simulation using the FEM and a verification process, the relationship between the stress and the LE space is quantified in a graph and the threshold stress is set, thereby changing or improving the design rule(s) with respect to the mask layout. Here, the design rules may include a design rule denoting the minimum line width of lines making up the pattern, a design rule denoting the minimum width at which the pattern needs to be maintained and a design rule denoting the minimum space that needs to be maintained between patterns when designing the mask layout. For reference, checking the design rule may be a mask rule check (MRC) and may be part of an OPC process that simulates the resulting pattern of the chip that is formed by the mask during manufacturing, which may take into consideration OPC features of the mask.

FIGS. 10A and 10B are conceptual views illustrating a shape optimization method applied to operation S150 of changing a design rule with respect to a mask layout, in the mask layout design method of FIG. 1. FIGS. 11A and 11B are images illustrating stress simulation results according to a shape optimization method. The description given with reference to FIG. 1 will be briefly explained or omitted.

Referring to FIGS. 10A and 10B, when patterns are formed to have the same width as shown in FIG. 10A, stress S1 may be concentrated on a lower part of the pattern by a load W pressing from above. That is, as may be seen through a graph with respect to a height H and the stress S1, the stress S1 may be the greatest at the lower part of the pattern and reduce toward an upper part of the pattern.

Meanwhile, as shown in FIG. 10B, when the pattern is formed to have a width increasing toward the lower part of the pattern, stress S2 at the lower part of the pattern may be relieved. That is, as may be seen through a graph with respect to the height H and the stress S2, the stress S2 may be substantially the same in the upper part and the lower part of the pattern. As a result, it may be seen that stress may be prevented from being concentrated in any one part by changing a shape or an arrangement position of the pattern. As described above, relieving stress by changing the shape of the pattern is called shape optimization. Although the example of FIGS. 10A and 10B illustrate an example of relief from a vertically applied stress, similar relief from similar shape optimization may be obtained from horizontally applied stress (or stress in other directions).

Referring to FIGS. 11A and 11B, in the case of a circular pattern of FIG. 11A, it may be seen from stress simulation results that stress S3 concentrates on both outer parts of the circular pattern. Meanwhile, in the case of an oval pattern of FIG. 11B, the stress simulation results show that there is no part where stress greatly concentrates. Therefore, it may be seen that the stress may be prevented from being concentrated on both outer parts, by changing the circular pattern to the oval pattern.

Although the shape optimization method has been described with respect to rectangular and trapezoidal column shapes of FIGS. 10A and 10B and the circular and oval shapes of FIGS. 11A and 11B, the shape optimization method may actually require a more complex and precise process. For example, the stress may be prevented from being concentrated on one side and dispersed throughout the pattern and relieved, by precisely analyzing a geometric structure and a stress distribution of the pattern and optimizing the shape or topology of the pattern.

In the mask layout design method of the present embodiment, operation S150 of changing the design rule may include optimizing the shape or topology of a full-chip layout through the shape optimization method with respect to the pattern. Accordingly, in the mask layout design method of the present embodiment, a stress weak point caused by stress concentration may be removed, by relieving and dispersing the stress in the pattern through a change in the design rule(s) and a shape optimization.

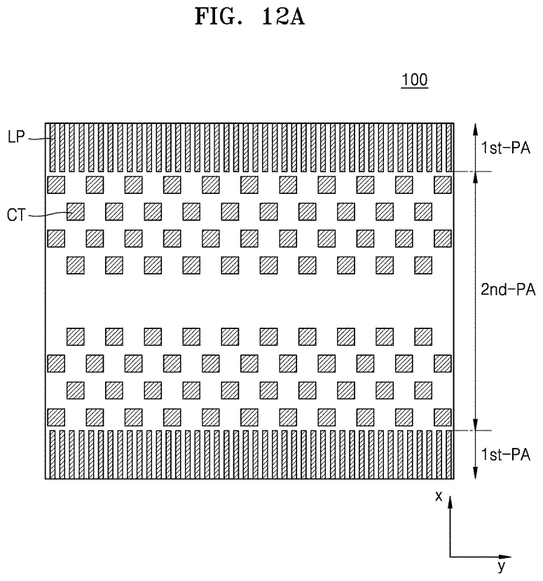

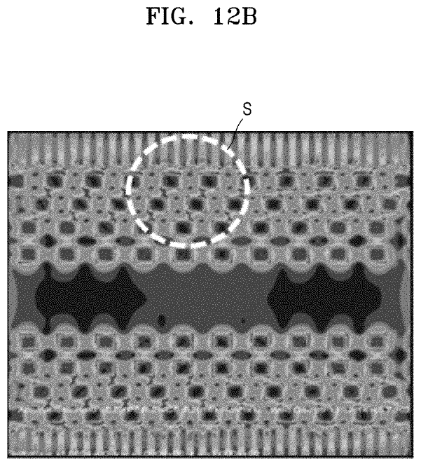

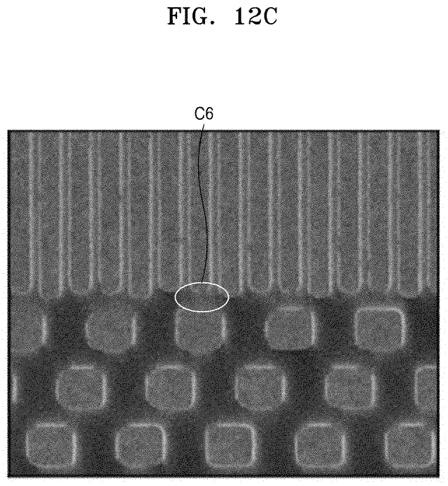

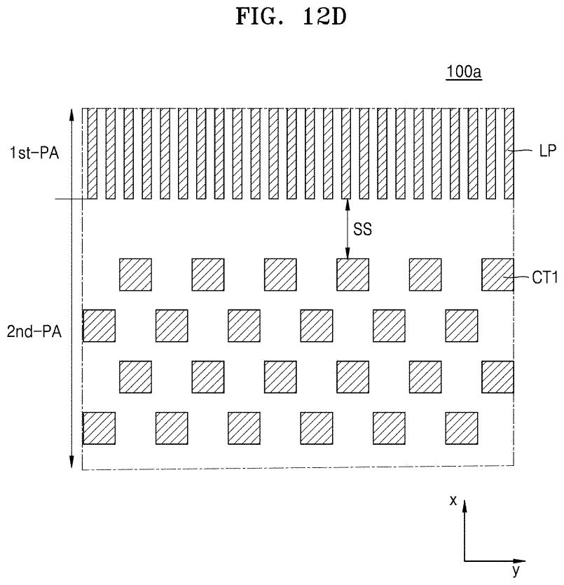

FIGS. 12A to 12D illustrate images of mask layouts 100 and 100a obtained by applying the mask layout design method of FIG. 1 to an actual semiconductor device. FIGS. 12C and 12D correspond to a magnified view of portion S of FIG. 12B. The descriptions given with reference to FIGS. 1 to 11B may be briefly explained or omitted.

Referring to FIG. 12A, in the mask layout design method of the present embodiment, in connection with operation S120 of extracting the representative pattern, the image of the mask layout 100 of the representative pattern obtained from a full-chip layout is shown. The mask layout 100 of the representative pattern may have a 2D GDS file format. However, the file format of the mask layout 100 of the representative pattern is not limited to the 2D GDS file format.

Describing the mask layout 100 of the representative pattern in more detail, the mask layout 100 of the representative pattern may include a first pattern area 1st-PA disposed in both sides in a first direction (x-direction) and a second pattern area 2nd-PA disposed in the center in the first direction (x-direction). Line patterns LP extending in the first direction (x-direction) and spaced apart from each other in a second direction (y-direction) may be disposed in the first pattern area 1st-PA. The line patterns LP may constitute a line-and-space pattern together with spaces therebetween. The contact pattern CT may be disposed in the second pattern area 2nd-PA. The contact patterns CT may be disposed in a 2D array structure in the second direction (y-direction). Meanwhile, the contact patterns CT may not be disposed in a central portion of the second pattern area 2nd-PA in the first direction (x-direction). A horizontal cross-section of the contact patterns CT may have a rectangular shape. However, the inventive concept is not limited thereto, and the horizontal cross-section of the contact patterns CT may have a circular shape, an oval shape, or a polygonal shape other than a square shape. Meanwhile, the mask layout 100 of the representative pattern shown in FIG. 12A may be, for example, a part of a layout forming a wiring layer of a vertical nonvolatile memory device. Also, the line patterns LP may correspond to wirings of the wiring layer, and the contact patterns CT may correspond to contacts of the wiring layer.

Referring to FIG. 12B, in the mask layout design method of the present embodiment, in connection with operation S130 of detecting the stress weak point, a black and white stress image is shown with respect to the representative pattern obtained in the stress simulation using the FEM. The process of obtaining the stress image of FIG. 12B may correspond to operation S136 of performing the stress simulation through the FEM in FIG. 4A. In the black and white image of FIG. 12B, a part indicated by a white dashed line may correspond to the stress weak point S of high stress. It may be seen that the stress weak point S concentrates on a boundary between the line patterns LP of the first pattern area 1st-PA and the contact patterns CT of the second pattern area 2nd-PA.

In addition, before performing the stress simulation using the FEM, a process of converting a 2D GDS file with respect to the mask layout 100 of the representative pattern into a 3D CAD file may be performed. In addition, a process of setting a physical property and a process condition with respect to the representative pattern and generating a mesh for analysis may be performed. That is, operation S132 of converting the 2D GDS file into the 3D CAD file and operation S134 of generating the mesh in FIG. 4A may be performed in advance.

Referring to FIG. 12C, in the mask layout design method of the present embodiment, in connection with verifying operation S140, a black and white SEM image is shown with respect to the pattern on the wafer. A process of obtaining the SEM image in FIG. 12C may correspond to operation S146 of detecting a pattern using an IL-SEM in FIG. 6. Before operation S146 of detecting the pattern using the IL-SEM, operation S142 of generating a mask and operation S144 of forming the pattern on the wafer may be performed. In the black and white image of FIG. 12C, it may be confirmed that a crack C6 actually occurs in a part indicated by a white oval. It may be seen that a position of the crack C6 is included in the stress weak point S of the black and white image of FIG. 12B above. Accordingly, the accuracy of operation S130 of detecting the stress weak point or the accuracy of the stress simulation using the FEM may be verified.

Referring to FIG. 12D, in the mask layout design method of the present embodiment, in connection with operation S120 of extracting the representative pattern from operation S150 of changing the design rule, an image of the mask layout 100a of the representative pattern extracted from a newly designed full-chip layout (e.g., a modified full-chip layout) is shown. Specifically, operation S150 of changing the design rule includes changing the design rule with respect to the full-chip layout, based on results of operation S130 of detecting the stress weak point and verifying operation S140. Further, the process proceeds to operation S110 of designing the layout, and operation S110 of designing the full-chip layout includes newly designing the full-chip layout with respect to the mask according to the changed design rule. Thereafter, operation S120 of extracting the representative pattern includes extracting the representative pattern from the new full-chip layout again.

A structure of the mask layout 100a of the representative pattern from the new full-chip layout is different from that of the mask layout 100 of the representative pattern as follows. In the mask layout 100 of the previous representative pattern, the contact patterns CT of the second pattern area 2nd-PA are disposed very close to the line patterns LP of the first pattern area 1st-PA in the first direction (x-direction). For example, spaces between the contact patterns CT and the line patterns LP in the first direction (x-direction) are less than a width of the contact pattern CT. In contrast, in the mask layout 100a of the new representative pattern, contact patterns CT1 of the second pattern area 2nd-PA are disposed from the line patterns LP of the first pattern area 1st-PA in the first direction (x-direction) by a set minimum separation space SS. In this example, the minimum separation space SS is greater than the width of the contact pattern CT in the first direction (x-direction) and thus greater than the corresponding minimum space of mask layout 100. Note that when the contact pattern CT has a circular, oval, or polygonal shape rather than a quadrangle shape, the diameter or short axis of the contact pattern CT may be used as a comparison target.

The mask layout of the present embodiment is designed through the method of designing a mask layout of FIG. 1, and thus, stress is minimized such that the mask layout may be strong against cracks. Accordingly, the mask layout of the present embodiment may make it possible to manufacture a reliable mask, and also to manufacture a reliable semiconductor device resistant to cracks through the mask.

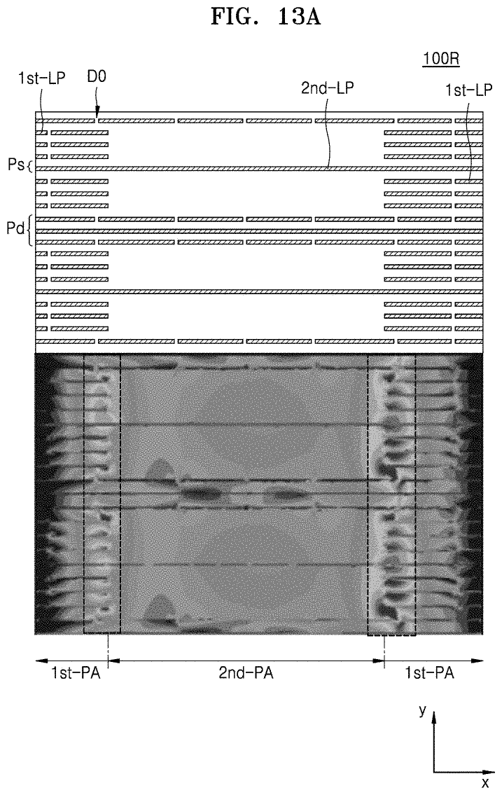

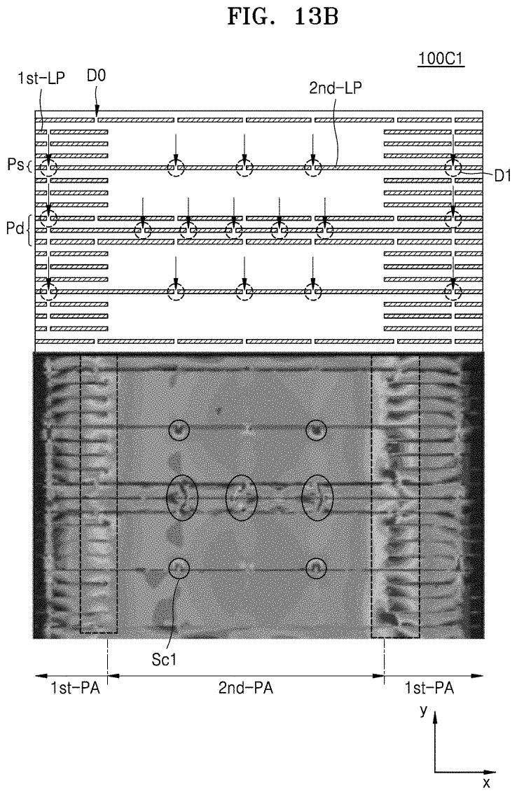

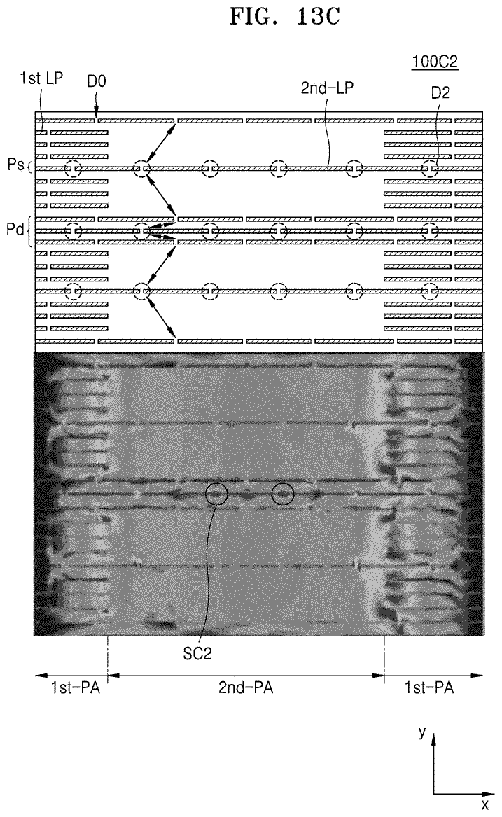

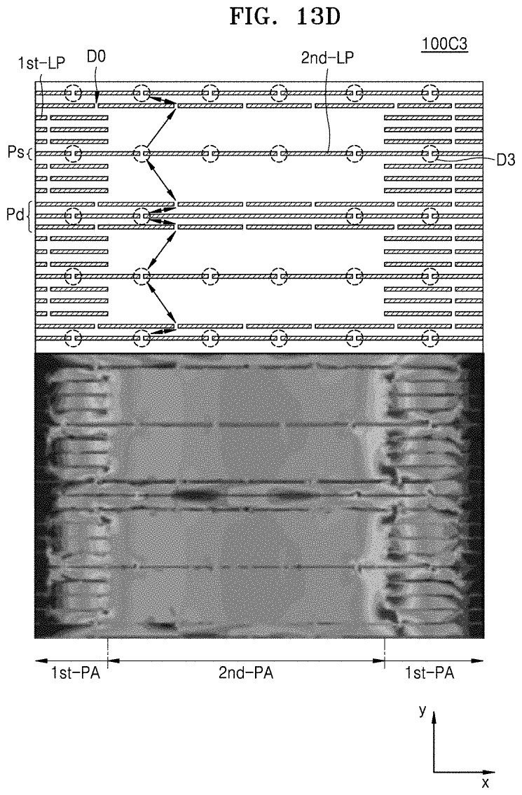

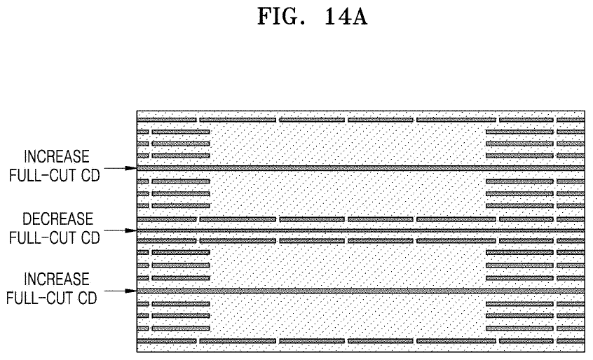

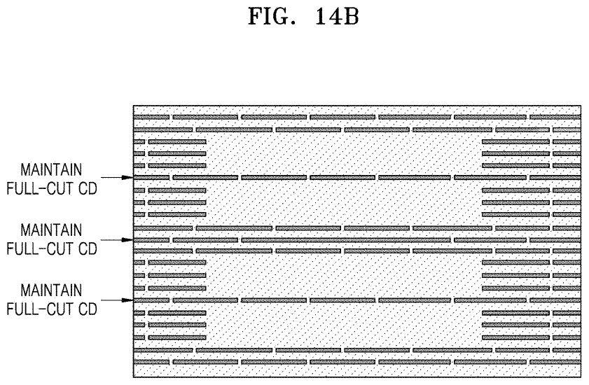

FIGS. 13A to 13D illustrate images of mask layouts 100R, 100C1, 100C2, and 100C3 obtained by applying the mask layout design method of FIG. 1 to an actual semiconductor device, and respectively illustrate stress images corresponding to the mask layout on lower parts. FIGS. 14A and 14B are plan views of semiconductor devices corresponding to the mask layouts 100R, and 100C3 of FIGS. 13A and 13D. The descriptions given with reference to FIGS. 1 to 12D will be briefly explained or omitted.

Referring to FIGS. 13A to 14B, FIG. 13A illustrates the image of the mask layout 100R of a reference representative pattern extracted from a reference mask layout, FIG. 13B illustrates the image of the mask layout 100C1 of a first representative pattern extracted from a mask layout of a first case, FIG. 13C illustrates the image of the mask layout 100C2 of a second representative pattern extracted from a mask layout of a second case, and FIG. 13D illustrates the image of the mask layout 100C3 of a third representative pattern extracted from a mask layout of a third case. The mask layouts 100R, 100C1, 100C2, and 100C3 of the representative patterns may each have be represented with a corresponding 2D GDS file format. However, file formats of the layouts 100R, 100C1, 100C2, and 100C3 of the representative patterns are not limited to the 2D GDS file format.

When describing the layouts 100R, 100C1, 100C2, and 100C3 of the representative patterns in more detail, each of the layouts 100R, 100C1, 100C2, and 100C3 of the representative patterns may include the first pattern area 1st-PA disposed in both sides in the first direction (x-direction) and the second pattern area 2nd-PA disposed in the center in the first direction (x-direction). First line patterns 1st-LP extending in the first direction (x-direction) and spaced apart from each other in a second direction (y-direction) may be disposed in the first pattern area 1st-PA. The first line patterns 1st-LP may constitute a line-and-space pattern together with spaces therebetween. Second line patterns 2nd-LP extending in the first direction (x-direction) in some of the first line patterns 1st-LP may be disposed in the second pattern area 2nd-PA. Meanwhile, the second pattern area 2nd-PA may include a dense area Pd in which a plurality of second line patterns, for example, three second line patterns 2nd-LP, are disposed in the second direction (y-direction), and a sparse area Ps in which one second line pattern 2nd-LP is disposed. The dense area Pd and the sparse area Ps may be alternately with each other disposed by a certain interval in the second direction (y-direction).

Each of the layouts 100R, 100C1, 100C2, and 100C3 of the representative pattern shown in FIGS. 13A to 13D may be, for example, a part of a layout forming a top supporter in a vertical nonvolatile memory device, and the first line patterns 1st-LP and the second line patterns 2nd-LP may correspond to cut lines formed in the top supporter. Meanwhile, the cut lines may be divided into an H-cut line in which cut portions D0 to D3 are disposed and a full-cut line in which no cut portion is present. Considering areas in a lower portion of the vertical nonvolatile memory device, the first pattern area 1st-PA may correspond to an extension area, and the second pattern area 2nd-PA may correspond to a cell area or a through-hole via (THV) arrangement area.

The layout 100R of the reference representative pattern may include the first line patterns 1st-LP and the second line patterns 2nd-LP respectively corresponding to the full-cut line and the H-cut line. In contrast, the layouts 100C1, 100C2, and 100C3 of the first to third representative patterns may include the first line patterns 1st-LP and the second line patterns 2nd-LP both corresponding to the H-cut line. Also, the layouts 100C1, 100C2, and 100C3 of the first to third representative patterns may correspond to layouts obtained by improving the layout 100R of the reference representative pattern.

More specifically, when the full-cut line is formed on the top supporter with the layout 100R of the reference representative pattern, a width at which the full-cut line is required may not be maintained due to shrinkage and leaning of a mold, etc. Accordingly, the layouts 100C1, 100C2, and 100C3 of the first to third representative patterns may be layouts obtained by solving such a problem by adding the cut portions D1 to D3 to the full-cut line.

The top supporter may be a structure formed on an upper portion of a mold to support the collapse or leaning of the mold, and the cut line may function as a kind of passage removing a mold disposed on a lower portion. However, among the cut lines, the full-cut line completely separates the mold on both sides, and thus a shape of the full-cut line may be deformed by shrinkage and leaning of the mold on both sides before removal of the mold, and a function of the cut-line may deteriorate afterwards. For example, FIG. 14A illustrates the semiconductor device formed based on a mask layout including the layout 100R of the reference representative pattern of FIG. 13A, in which it may be seen that a width or a CD of an existing full-cut line in the center is less than that of another full-cut line or H-cut line. Also, it may be seen that widths or CDs of upper and lower existing full-cut lines are greater than those of other H-cut lines.

Accordingly, as in the layouts 100C1, 100C2, and 100C3 of the first to third representative patterns, the previous problem may be solved by adding the cut portion to the full-cut line to connect the molds on both sides to each other in the shape of the H-cut line. For example, FIG. 14B illustrates the semiconductor device formed based on a mask layout including the layout 100C3 of the third representative pattern of FIG. 13D, in which it may be seen that the width or the CD of the existing full-cut lines is maintained similar to that of other H-cut lines.

When describing a structure of each of the layouts 100C1, 100C2, and 100C3 of the first to third representative patterns, in the case of the layout 100C1 of the first representative pattern, the first cut portion D1 may be disposed regardless of a position of a basic cut portion D0 of the original H-cut line while added to each of the full-cut lines of the layout 100R of the reference representative pattern. Accordingly, as seen through arrows in FIG. 13B, the first cut portion D1 and the basic cut portion D0 may be disposed at the same or similar positions in the first direction (x direction). In FIGS. 13B to 13D, the newly added first to third cut portions D1 to D3 are indicated by dashed circles.

In the case of the layout 100C2 of the second representative pattern, the second cut portion D2 may be arranged to alternate with the position of the basic cut portion D0 of the original H-cut line in the first direction (x direction) while added to each of the full-cut lines of the layout 100R of the reference representative pattern. Accordingly, as seen through arrows in FIG. 13C, the second cut portion D2 and the basic cut portion D0 may be arranged in a zigzag shape in the second direction (y direction).

The layout 100C3 of the third representative pattern may be basically similar to the layout 100C2 of the second representative pattern, but the number of third cut parts D3 added to a central full-cut line may be smaller than the number of second cut portions D2. For example, in the case of the layout 100C2 of the second representative pattern, six second cut portions D2 are added to the central full-cut line, but in the case of the layout 100C3 of the third representative pattern, four third cut portions D3 may be added to the central full-cut line.

When analyzing results of a stress simulation shown below, in the case of the layout 100R of the reference representative pattern, although stress is high at the boundary of the first pattern area 1st-PA and the second pattern area 2nd-PA, which are indicated by dashed long squares, this corresponds to stress caused by a step difference, which may not be removed by adding a separation part. It may be seen that there is no separate high stress part in the second pattern area 2nd-PA.

In the case of the layout 100C1 of the first representative pattern, as the first cut portion D1 is added, it may be seen that a stress weak point Sc1 is generated in the second pattern area 2nd-PA. In addition, in the case of the layout 100C2 of the second representative pattern, it may be seen that as the second cut portion D2 is added in a zigzag form, stress weak points are removed to some extent, but a stress weak point Sc2 is still present in a central full-cut line part. Meanwhile, in the case of the layout 100C3 of the third representative pattern, it may be seen that the third cut portion D3 is formed less in the central full-cut line part, so that the stress weak point is completely removed in the second pattern area 2nd-PA.

Accordingly, when a mask and a semiconductor device are formed based on the mask layout including the layout 100C3 of the third representative pattern, it may be predicted that shape deformation of a full-cut line may be prevented, and also, a stress weak point may be prevented from being newly generated.

FIG. 15 is a flowchart schematically illustrating a manufacturing method according to an embodiment of the present invention. The manufacturing method of FIG. 15 may be used to manufacture a mask and a semiconductor device using the mask, and may include any of the mask layout design methods described herein. The descriptions given with reference to FIGS. 1 to 14B will be briefly explained or omitted.

Referring to FIG. 15, the manufacturing method includes a mask layout design method and includes first performing the mask layout design method (S210). The mask layout design method may be the same as described above with respect to the mask layout design method of FIG. 1.

Thereafter, OPC is performed on a final full-chip layout obtained through the mask layout design method (S220). As a pattern is miniaturized, an optical proximity effect (OPE) due to an effect between neighboring patterns occurs during an exposure process, and to overcome the OPE, OPC may be performed to correct a mask layout and suppress occurrence of undesired OPE. OPC may include a process of generating an optical image of a corresponding pattern, generating an OPC model, and obtaining an image or data with respect to a mask layout through simulation using the OPC model.

The overall description of OPC is as follows. OPC is largely divided into two types, one is rule-based OPC, and the other is simulation-based or model-based OPC. OPC in the mask layout correction method of the present embodiment may be, for example, the model-based OPC. The model-based OPC may be advantageous in terms of time and cost because the model-based OPC uses only measurement results of representative patterns without having to measure all of a large number of test patterns. Meanwhile, OPC may include a method of adding sub-lithographic features called serifs on the corners of a pattern, as well as a modification of the mask layout, or a method of adding sub-resolution assist features (SRAFs) such as scattering bars. OPC, first, prepares basic data for OPC. Here, the basic data may include data about shapes of patterns of a sample, positions of the patterns, a type of measurement such as measurement of a space or line of the pattern, and a basic measurement value. In addition, the basic data may include information such as thickness, refractive index, and dielectric constant of a PR, and may include a source map with respect to a type of an illumination system. However, the basic data is not limited to the data described above.

After preparation of the basic data, an optical OPC model is generated. Generation of the optical OPC model may include optimization of a defocus stand (DS) position, a best focus (BF) position, etc. in an exposure process. In addition, the generation of the optical OPC model may include generation of the optical image considering diffraction of light or an optical state of exposure equipment itself. However, the generation of the optical OPC model is not limited to the description given above. For example, the generation of the optical OPC model may include various contents related to optical phenomena in the exposure process.

After the generation of the optical OPC model, an OPC model for PR is generated. Generation of the OPC model for PR may include optimization of a threshold value of PR. Here, the threshold value of PR means a threshold value at which a chemical change occurs in the exposure process, and, for example, may be given as the intensity of exposure light. The generation of the OPC model for PR may also include selecting an appropriate model form from several PR model forms.

The optical OPC model and the OPC model for PR are collectively referred to as the OPC model. After the generation of the OPC model, a simulation is repeated using the OPC model. The simulation may be performed until a certain condition is satisfied. For example, a root mean square (RMS) with respect to a CD error, an edge placement error (EPE), a reference number of repetitions, etc. may be used as repetition conditions of the simulation. In the mask layout correction method of the present embodiment, images or data of optical proximity corrected layout may be obtained through simulation using the OPC model. Thus, the patterns of the full-chip layout may be represented in a corresponding mask as modified by the OPC model.

Thereafter, data of the optical proximity corrected full-chip layout is transferred as MTO design data to a mask manufacturing team (S230). Thus, the MTO design data may substantially represent the same mask structure as the data of the optical proximity corrected full-chip layout. The MTO design data may have a graphic data format used in electronic design automation (EDA) software, etc. For example, the MTO design data may have a data format such as Graphic Data System II (GDS2) and Open Artwork System Interchange Standard (OASIS).

Thereafter, mask data preparation (MDP) is performed (S240). MDP may include, for example, i) format conversion, called fracturing, ii) augmentation of barcodes for mechanical reading, standard mask patterns for inspection, a job deck, etc., and iii) verification of automatic and manual methods. Here, the job deck may mean creating a text file related to a series of instructions, such as arrangement information of multiple mask files, a reference dose, and an exposure speed or method.

Meanwhile, the format conversion, that is, fracturing, may mean a process of dividing the MTO design data for each area to change the MTO design data to a format for an electron beam exposure machine. Fracturing may include, for example, data manipulation such as scaling, sizing data, rotation of data, pattern reflection, color inversion, etc. In a conversion process through fracturing, data with respect to numerous systematic errors that may occur anywhere during a transfer process from the design data to an image on a wafer may be corrected. A data correction process with respect to the systematic errors is called mask process correction (MPC), and may include, for example, line width adjustment called CD adjustment and an operation to increase pattern arrangement precision. Therefore, fracturing may contribute to improving the quality of a final mask and may also be a process proactively performed for MPC. Here, the systematic errors may be caused by distortion occurring in an exposure process, a mask development and etching process, and a wafer imaging process.

Meanwhile, MDP may include MPC. As described above, the MPC refers to a process of correcting an error occurring during the exposure process, that is, a systematic error. Here, the exposure process may be a concept that generally includes electron beam writing, developing, etching, and baking. In addition, data processing may be performed prior to the exposure process. Data processing is a kind of preprocessing process on mask data, and may include grammar check with respect to the mask data, prediction of exposure time, etc. Through the MDP, mask data in the form of E-beam data for exposing a mask blank may be generated.

After the MDP, a mask blank is patterned using the mask data to form the mask, such as by exposing a mask blank using the mask data (S250). Here, exposure may mean, for example, electron beam (E-beam) writing. For example, a mask blank may comprise an absorber (e.g., a layer of TaN Cr, or W, etc.) on a transparent substrate (e.g., SiO2). An electron beam may be provided by an electron gun to pattern the absorber layer via E-beam writing. Here, the E-beam writing may be performed by, for example, a gray writing method using a multi-beam mask writer (MBMW). In addition, the E-beam writing may be performed using a variable shape beam (VSB) exposure machine.

After the MDP, a process of converting E-beam data into pixel data before the exposure process may be performed. The pixel data is data directly used for actual exposure, and may include data about a shape to be exposed and data about a dose of an E-beam assigned to each piece of data. Here, the data about the shape may be bit-map data in which shape data, which is vector data, is converted through rasterization.

After the exposure process, a series of processes may be performed to complete the mask. The series of processes may include, for example, development, etching, and cleaning of the absorber layer of the mask blank. Thus, the mask may be formed having a pattern (corresponding to a pattern of the full-chip layout) formed in the absorber layer. In addition, the series of processes for manufacturing the mask may include a measurement process, a defect inspection process, or a defect repair process. In addition, a pellicle application process may be included in the series of processes. Here, the pellicle application process may be a process of attaching a pellicle to a mask surface so as to protect the mask from subsequent contamination during a delivery of the mask and an available life of the mask when it is confirmed that there are no contaminant particles or chemical stains through final cleaning and inspection.

After forming the mask, a semiconductor device may be formed by using the mask in a photolithographic process (S260). For example, a target layer (e.g., a semiconductor substrate or a layer formed on a semiconductor substrate of a wafer) may be patterned using the by depositing a photoresist layer on the target layer, patterning the photoresist layer via photolithographic exposure (selective exposure of the photoresist layer with the mask) and developing (or dissolving in a chemical developer) the exposed photoresist layer (removing the either the exposed portion or the non-exposed portion of the photoresist layer) to form a photoresist pattern. The photoresist pattern may then be used as a mask to etch the target layer (below the photoresist pattern) to transfer the pattern of the photoresist pattern to the target layer. In some examples, this patterned target layer may form a hard mask that is used to pattern another target layer on which the hard mask is formed. The patterned target layer may form portions of an integrated circuit of the semiconductor device, and have a pattern of the full-chip layout as described herein. Additional manufacturing steps of singulating (e.g., cutting) the semiconductor device from the wafer on which it is formed and packaging the semiconductor device may be performed.

While the inventive concept has been particularly shown and described with reference to embodiments thereof, it will be understood that various changes in form and details may be made therein without departing from the spirit and scope of the following claims.

1. A manufacturing method comprising:
designing a full-chip layout;
extracting a representative pattern from the full-chip layout;
detecting a stress weak point in the representative pattern by performing a simulation;
verifying the detected stress weak point including forming a pattern on a wafer;
in response to the detected stress weak point, changing a design rule with respect to the full-chip layout to obtain a modified full-chip layout; and
forming at least one of a mask and a semiconductor chip in response to analysis of the modified full-chip layout.

2. The manufacturing method of claim 1, wherein the extracting of the representative pattern comprises: extracting the representative pattern by identifying a pattern in the full-chip layout that is repeated in the full-chip layout as the representative pattern.

3. The manufacturing method of claim 1, wherein the extracting of the representative pattern comprises:
receiving an input of the full-chip layout; and
extracting a unique pattern as the representative pattern and storing the unique pattern using a hash code,
wherein the unique pattern is a pattern of the full-chip layout that has not been previously identified.

4. The manufacturing method of claim 1,
wherein the extracting of the representative pattern uses a pattern matching method of comparing a previously identified pattern to the full-chip layout and extracting a corresponding pattern as the representative pattern.

5. The manufacturing method of claim 1, wherein the detecting of the stress weak point comprises detecting the stress weak point based on a stress simulation using a finite element method (FEM).

6. The manufacturing method of claim 5, wherein the detecting of the stress weak point further comprises:
converting a two-dimensional representation of the representative pattern into a three-dimensional representation of the representative pattern;
setting a physical property and a process condition with respect to the three-dimensional representation of the representative pattern;
generating a mesh for FEM analysis that divides the three-dimensional representation of the representative pattern into cells; and
performing the stress simulation using the FEM.

7. The manufacturing method of claim 1, wherein the changing of the design rule with respect to the full-chip layout comprises changing the design rule with respect to the full-chip layout by performing optimization of a shape or a topology of the full-chip layout by using a shape optimization method.

8. The manufacturing method of claim 7, wherein the shape optimization method changes the shape or the topology of the full-chip layout so that stress of the stress weak point is reduced to be less than or equal to a set reference stress value.

9. The manufacturing method of claim 1, wherein the verifying the stress weak point by forming the pattern on the wafer comprises:
generating an initial mask based on the full-chip layout;
forming the pattern on the wafer by using the initial mask; and
detecting the pattern on the wafer with a scanning electron microscope (SEM).

10. The manufacturing method of claim 1, further comprising analyzing the modified full-chip layout including extracting a representative pattern from the modified full-chip layout and performing a simulation to evaluate the existence of a stress weak point in the representative pattern of the modified full-chip.

11. A manufacturing method comprising:
designing a first layout;
extracting a representative pattern from the first layout through a unique pattern extraction method;
detecting a stress weak point based on a stress simulation using a finite element method (FEM) with respect to the representative pattern;
verifying the detected stress weak point including forming a pattern on a wafer;
in response to the detected stress weak point, changing a design rule with respect to the first layout by using a shape optimization method;
designing a second layout according to the changed design rule; and
forming at least one of a mask and a semiconductor chip in response to analysis of the second layout,
wherein the first layout and the second layout are layouts with respect to a full-chip.

12. The manufacturing method of claim 11, wherein the extracting of the representative pattern comprises:
receiving an input of the first layout; and
extracting a unique pattern as the representative pattern and storing the unique pattern in a database,
wherein the unique pattern is a pattern of the full-chip layout that has not been previously stored in the database.

13. The manufacturing method of claim 11, wherein the detecting of the stress weak point comprises:
converting a two-dimensional representation of the representative pattern into a three-dimensional representation of the representative pattern;
setting a physical property and a process condition with respect to the three-dimensional representation of the representative pattern;
generating a mesh for FEM analysis that divides the three-dimensional representation of the representative pattern into cells; and
performing the stress simulation using the FEM.

14. The manufacturing method of claim 11, wherein the shape optimization method changes a shape or a topology of the first layout so that stress of the stress weak point is reduced to be less than or equal to a set reference stress value.

15. The manufacturing method of claim 11, wherein the verifying the stress weak point by forming the pattern on the wafer comprises:
generating a first mask based on the first layout;
forming the pattern on the wafer by using the first mask; and
detecting the pattern on the wafer through a scanning electron microscope (SEM).

16. A manufacturing method comprising:
performing a mask layout design method;
performing optical proximity correction (OPC) on a final full-chip layout obtained through the mask layout design method;
transferring data of the optical proximity corrected full-chip layout as mask tape-out (MTO) design data;
preparing mask data based on the MTO design data; and
exposing a mask blank based on the mask data,
wherein the performing of the mask layout design method comprises:
designing a full-chip layout;
extracting a representative pattern from the full-chip layout;
detecting a stress weak point in the representative pattern by performing a simulation;
verifying the detected stress weak point including forming a pattern on a wafer; and
in response to the detected stress weak point, changing a design rule with respect to the full-chip layout.

17. The manufacturing method of claim 16, wherein the extracting of the representative pattern uses a pattern matching method of comparing a previously identified pattern to the full-chip layout and extracting a corresponding pattern as the representative pattern.

18. The manufacturing method of claim 16, further comprising, before detecting the stress weak point, converting a two-dimensional representation of the representative pattern into a three-dimensional representation of the representative pattern,
wherein the detecting of the stress weak point comprises: setting a physical property and a process condition with respect to the three-dimensional representation of the representative pattern, generating a mesh for FEM analysis that divides the three-dimensional representation of the representative pattern into cells, and then performing a stress simulation using a finite element method (FEM).

19. The manufacturing method of claim 16, wherein the changing of the design rule with respect to the full-chip layout comprises changing the design rule with respect to the full-chip layout by performing optimization of a shape or a topology of the full-chip layout by using a shape optimization method.

20. The manufacturing method of claim 16, wherein the verifying the stress weak point by forming the pattern on the wafer comprises:
generating an initial mask based on the full-chip layout;
forming the pattern on the wafer by using the initial mask; and
detecting the pattern on the wafer with a scanning electron microscope (SEM).

21-26. (canceled)
